(19) United States
(12) Patent Application Publication
(10) Pub. No.: US 2015/0175456 A1
(43) Pub. Date: Jun. 25, 2015

(54) BIOLOGICAL DENITROGENATION METHOD USING SLOW RELEASE SOLID CARBON SOURCE

(71) Applicant: TONGJI UNIVERSITY, SHANGHAI (CN)

(72) Inventors: Yinguang Chen, Shanghai (CN); Huaichen Wang, Shanghai (CN); Shu Zhao, Shanghai (CN); Fansong Meng, Shanghai (CN)

(21) Appl. No.: 14/416,247

(22) PCT Filed: Jun. 25, 2013
(86) PCT No.: PCT/CN2013/077839

§ 371 Date: Jan. 21, 2015

(30) Foreign Application Priority Data
Jul. 24, 2012 (CN) 201210257913.2

(51) Int. Cl. C02F 3/32; C02F 3/28

(52) U.S. Cl. CPC C02F 3/32; C02F 3/28; C02F 2101/163

(57) ABSTRACT

Disclosed is a method for biological denitrification of water body polluted by nitrates using sustained-release solid carbon sources comprising the following steps: add cassava lees into water body polluted by nitrates for denitrification of the waste water, It can achieve the purpose of biological nitrogen removal through slowly releasing organic carbons as carbon sources for microbial denitrification in the water by cassava lees and the cassava lees losing the carbon-releasing function can be naturally degraded in the environment without causing secondary pollution.

### TECHNICAL FIELD

The present invention relates to the field of environmental protection, which relates to a method for biological denitrification of the water body polluted by nitrates using sustained-release solid carbon sources.

### BACKGROUND ART

At present, the surface water and groundwater in an increasing number of countries in the globe is seriously polluted by nitrates, whereas sources of drinking water for people are mainly groundwater and surface water which in consequence threatens drinking water safety for people to a great extent. Intake of excess nitrates into human bodies for a long period of time can lead to methemoglobinemia, or even cancer. US Environmental Protection Association has given a standard which requires the concentration of nitrate in drinking water should be lower than 10 mg/L. Currently, there are a variety of methods to remove the nitrate nitrogen from the water, such as ion exchange method, reverse osmosis method and biological nitrogen removal method, and so on. Among these methods, biological nitrogen removal method attracts the most considerable attention due to its safety, high efficiency and low costs, etc.

Biological nitrogen removal is a process of gradual reduction of nitrate radical to the nitrogen gas (NO₃⁻→NO₂⁻→NO→N₂O→N₂) under the actions of denitrifying microorganisms. This process is carried out under a series of enzymatic reactions (see the literature Process Biochemistry, 2006, 41:1289-1295). During the whole denitrification process, the nitrate nitrogen, as the electron acceptor, needs to be provided with electron by organic carbon; however, due to insufficient carbon sources, the denitrification effect is not ideal. For so long, to enhance the denitrification effect, people often add methanol, acetic acid and other liquid carbon sources as supplementary carbon sources. These liquid carbon sources have the advantages of quick release and easy utilization by microorganisms, etc., but have such problems as difficult control of dosage, frequent addition, and easily resulting in secondary pollution, etc.

Because of having the advantages of slow release, sustainable supply of carbon sources after one time dosing, long-lasting denitrification process, etc, solid carbon sources become more suitable carbon sources for denitrification of water body polluted by nitrates. There are a variety of solid carbon sources, including synthetic macromolecular materials (see the literature Bioresource Technology, 2011, 102: 8835-8838); natural cellulosic materials such as cotton, licorice, bark (see literature Process Biochemistry, 2006, 41: 1539-1544), and etc. Among them, the synthetic solid carbon sources can achieve better nitrogen removal effect due to their better granularity and easier control of carbon-releasing amount, but the production cost of them is higher.

Cassava, as a cash crop, has very high starch content and is a kind of important raw material for industrial production of alcohol. Cassava lees, as the residues of cassava in preparation of alcohol, have very high yield, and their major compositions are cellulose, lignin and other organic matters (see the literature Bioresource Technology, 2000, 74: 81-87). However, till now, it still has not been reported to use cassava lees as the sustained-release solid carbon sources for biological denitrification of nitrogen.

### SUMMARY OF THE INVENTION

The present invention aims to overcome the deficiencies of the prior art and provide a method for biological denitrification of water body polluted by nitrates. This method adopts cassava lees as the solid carbon sources for biological denitrification, which can realize the biological nitrogen removal of the water body polluted by nitrates, and at the same time provide means of utilization of a large quantity of cassava lees as resources.

To achieve the above purposes, the present invention employs the following technical schemes:

A method for biological denitrification of wastewater containing nitrates comprises the following steps: add cassava lees into water body polluted by nitrates for denitrification.

The concentration of nitrate in the water body polluted by nitrates before treatment is 2-80 mg/L.

The mass ratio of added cassava lees to nitrate nitrogen in the water body polluted by nitrates is 3:1-150:1, preferably 15:1-25:1 (i.e., the optimal dosage of the cassava lees is preferably 15-25 g cassava lees/g NO₃⁻—N).

The duration of the denitrification is 6-18 days.

The duration of the denitrification is 14 days.

The temperature of the denitrification is 5-30° C., preferably 20° C.

In the present invention, the cassava lees are used in the water body of natural river course which is polluted by nitrates and can be used in all the water body polluted by nitrates, including underground water.

The biological denitrification to remove nitrogen in the present invention is to make use of denitrification of denitrifying microorganisms and treat nitrates as the electron receptor to gradually reduce nitrate radical to nitrogen gas, which is, NO₃⁻→NO₂⁻→NO→N₂O→N₂. The main denitrifying microorganisms are heterotropic microorganisms, which need to utilize the carbon sources provided by the outside. The cassava lees can continuously and slowly provide denitrifying microorganisms with the carbon sources to achieve denitrification by the use of their sustained release, which can overcome the shortcomings of frequent addition of traditional liquid carbon sources.

The present invention can achieve the following beneficial effects. The present invention is particularly convenient to operate, which can be done only by just adding a certain quantity of cassava lees according to the nitrate concentration in the water body. It can achieve the purpose of biological nitrogen removal mainly through sustainedly releasing organic carbons as carbon sources for microbial denitrification in the water by cassava lees.

(1) It provides an excellent solid carbon source for the treatment of nitrate pollution in water body through biological denitrification method. The carbon sources overcome the shortcomings of the need for frequent addition of the liquid carbon sources. By adding the solid carbon source of the present invention one time, the solid carbon source can slowly and continuously release the organic substances to ensure efficient and sustained nitrogen removal. In addition, it has been found by tests that in the end, the final COD concentration is relatively low; and after losing the carbon-releasing function, it can be naturally degraded in the environment without causing secondary pollution.

(2) It provides a new approach for utilization of cassava lees as resource, which avoids the waste of resources and reduce their pollutions to the environment.

(3) It is unnecessary to separate the cassava lees after treatment, because the cassava lees are a kind of cellulose substance, which can be naturally degraded in nature after losing the carbon-releasing function.

### DETAILED DESCRIPTIONS OF THE PREFERRED EMBODIMENTS

Detailed illustrations are further made in connection with the following specific embodiments. However, it should be understood that the embodiments listed below only intend to illustrate the present invention and shouldn't be regarded as comprising the whole content of the present invention.

### Embodiment 1

Add the cassava lees (compositions of elements is C 32.33%, N 0.6%, H 5.16%) at a dosage of 0.02 g/L into a river water simulation device with nitrate nitrogen concentration of 2.0 mg/L (the mass ratio of cassava lees to nitrate nitrogen is 10:1) and place it in a condition of 20° C. 14 days later, the concentration of nitrate nitrogen is 0.25 mg/L, the concentration of nitrite nitrogen is 0 mg/L, the COD is 29 mg/L and the final nitrogen removal rate is 87.5%. In the control group without addition of cassava lees, the nitrogen removal rate is 4%. Thus, the effect of nitrogen removal is increased by about 22 times.

### Embodiment 2

Add the cassava lees at a dosage of 0.15 g/L into a river water simulation device with nitrate nitrogen concentration of 10.0 mg/L (the mass ratio of cassava lees to nitrate nitrogen is 15:1). Other procedures are carried out as the same as those of Embodiment 1. 14 days later, the concentration of nitrate nitrogen is 0.47 mg/L, the concentration of nitrite nitrogen is 0 mg/L, the COD is 33 mg/L and the final nitrogen removal rate is up to 95.3%. In the control group without addition of cassava lees, the nitrogen removal rate is 4%. Thus, the effect of nitrogen removal is increased by about 24 times.

### Embodiment 3

Add the cassava lees at a dosage of 0.25 g/L into a river water simulation device with nitrate nitrogen concentration of 10.0 mg/L (the mass ratio of cassava lees to nitrate nitrogen is 25:1). Other procedures are carried out as the same as those of Embodiment 1. 14 days later, the concentration of nitrate nitrogen is 0.38 mg/L, the concentration of nitrite nitrogen is 0 mg/L, the COD is 34.8 mg/L and the final nitrogen removal rate is up to 96.2%. In the control group without addition of cassava lees, the nitrogen removal rate is 4%. Thus, the effect of nitrogen removal is increased by about 24 times.

### Embodiment 4

Add the cassava lees at a dosage of 0.5 g/L into a river water simulation device with nitrate nitrogen concentration of 10.0 mg/L (the mass ratio of cassava lees to nitrate nitrogen is 50:1). Other procedures are carried out as the same as those of Embodiment 1. 14 days later, the concentration of nitrate nitrogen is 0.015 mg/L, the concentration of nitrite nitrogen is 0 mg/L, the COD is 52.8 mg/L and the final nitrogen removal rate is up to 99.8%. In the control group without addition of cassava lees, the nitrogen removal rate is 4%. Thus, the effect of nitrogen removal is increased by about 25 times.

### Embodiment 5

Add the cassava lees at a dosage of 1.0 g/L into a river water simulation device with nitrate nitrogen concentration of 10.0 mg/L (the mass ratio of cassava lees to nitrate nitrogen is 100:1). Other procedures are carried out as the same as those of Embodiment 1. 14 days later, the concentration of nitrate nitrogen is 0.0 mg/L, the concentration of nitrite nitrogen is 0 mg/L, and the COD is 66.4 mg/L, indicating that all nitrate nitrogen has been removed. In the control group without addition of cassava lees, the nitrogen removal rate is 4%. Thus, the effect of nitrogen removal is increased by about 25 times.

### Embodiment 6

Add the cassava lees at a dosage of 1.5 g/L into a river water simulation device with nitrate nitrogen concentration of 10.0 mg/L (the mass ratio of cassava lees to nitrate nitrogen is 150:1). Other procedures are carried out as the same as those of Embodiment 1. 14 days later, the concentration of nitrate nitrogen is 0.0 mg/L, the concentration of nitrite nitrogen is 0 mg/L, and the COD is 104.4 mg/L, indicating that all nitrate nitrogen has been removed. In the control group without addition of cassava lees, the nitrogen removal rate is 4%. Thus, the effect of nitrogen removal is increased by about 25 times.

### Embodiment 7

Add the cassava lees at a dosage of 0.25 g/L into a river water simulation device with nitrate nitrogen concentration of 10.0 mg/L (the mass ratio of cassava lees to nitrate nitrogen is 25:1) and place it in a condition of 5° C. 14 days later, the concentration of nitrate nitrogen is 1.5 mg/L, the concentration of nitrite nitrogen is 0 mg/L, the COD is 31.5 mg/L and the final nitrogen removal rate is up to 85%. In the control group without addition of cassava lees, the nitrogen removal rate is 4%. Thus, the effect of nitrogen removal is increased by about 21 times.

### Embodiment 8

Add the cassava lees at a dosage of 0.25 g/L into a river water simulation device with nitrate nitrogen concentration of 10.0 mg/L (the mass ratio of cassava lees to nitrate nitrogen is 25:1) and place it in a condition of 30° C. 14 days later, the concentration of nitrate nitrogen is 0.28 mg/L, the concentration of nitrite nitrogen is 0 mg/L, the COD is 36.5 mg/L and the final nitrogen removal rate is up to 97.2%. In the control group without addition of cassava lees, the nitrogen removal rate is 4%. Thus, the effect of nitrogen removal is increased by about 24 times.

### Embodiment 9

Add the cassava lees at a dosage of 0.25 g/L into a river water simulation device with nitrate nitrogen concentration of 40.0 mg/L (the mass ratio of cassava lees to nitrate nitrogen is 6.25:1). Other procedures are carried out as the same as those of Embodiment 1. 14 days later, the concentration of nitrate nitrogen is 22.75 mg/L, the concentration of nitrite nitrogen is 0 mg/L, the COD is 36.32 mg/L and the final nitrogen removal rate is up to 43.1%. In the control group without addition of cassava lees, the nitrogen removal rate is 4%. Thus, the effect of nitrogen removal is increased by about 11 times.

### Embodiment 10

Add the cassava lees at a dosage of 0.5 g/L into a river water simulation device with nitrate nitrogen concentration of 40.0 mg/L (the mass ratio of cassava lees to nitrate nitrogen is 12.5:1). Other procedures are carried out as the same as those of Embodiment 1. 14 days later, the concentration of nitrate nitrogen is 8.84 mg/L, the concentration of nitrite nitrogen is 0 mg/L, the COD is 43.3 mg/L and the final nitrogen removal rate is up to 77.9%. In the control group without addition of cassava lees, the nitrogen removal rate is 4%. Thus, the effect of nitrogen removal is increased by about 19 times.

### Embodiment 11

Add the cassava lees at a dosage of 1.0 g/L into a river water simulation device with nitrate nitrogen concentration of 40.0 mg/L (the mass ratio of cassava lees to nitrate nitrogen is 25:1). Other procedures are carried out as the same as those of Embodiment 1. 14 days later, the concentration of nitrate nitrogen is 0.075 mg/L, the concentration of nitrite nitrogen is 0 mg/L, the COD is 64.8 mg/L and the final nitrogen removal rate is up to 99.8%. In the control group without addition of cassava lees, the nitrogen removal rate is 4%. Thus, the effect of nitrogen removal is increased by about 25 times.

### Embodiment 12

Add the cassava lees at a dosage of 1.5 g/L into a river water simulation device with nitrate nitrogen concentration of 40.0 mg/L (the mass ratio of cassava lees to nitrate nitrogen is 37.5:1). Other procedures are carried out as the same as those of Embodiment 1. 14 days later, the concentration of nitrate nitrogen is 0.15 mg/L, the concentration of nitrite nitrogen is 0 mg/L, the COD is 114.4 mg/L and the final nitrogen removal rate is up to 99.6%. In the control group without addition of cassava lees, the nitrogen removal rate is 4%. Thus, the effect of nitrogen removal is increased by about 25 times.

### Embodiment 13

Add the cassava lees at a dosage of 2.0 g/L into a river water simulation device with nitrate nitrogen concentration of 40.0 mg/L (the mass ratio of cassava lees to nitrate nitrogen is 50:1). Other procedures are carried out as the same as those of Embodiment 1. 14 days later, the concentration of nitrate nitrogen is 0.11 mg/L, the concentration of nitrite nitrogen is 0 mg/L, the COD is 153.2 mg/L and the final nitrogen removal rate is up to 99.7%. In the control group without addition of cassava lees, the nitrogen removal rate is 4%. Thus, the effect of nitrogen removal is increased by about 25 times.

### Embodiment 14

Add the cassava lees at a dosage of 1.0 g/L into a river water simulation device with nitrate nitrogen concentration of 40.0 mg/L (the mass ratio of cassava lees to nitrate nitrogen is 25:1) and place it in a condition of 5° C. 14 days later, the concentration of nitrate nitrogen is 2.6 mg/L, the concentration of nitrite nitrogen is 0 mg/L, the COD is 52 mg/L and the final nitrogen removal rate is up to 93.5%. In the control group without addition of cassava lees, the nitrogen removal rate is 4%. Thus, the effect of nitrogen removal is increased by about 23 times.

### Embodiment 15

Add the cassava lees at a dosage of 1.0 g/L into a river water simulation device with nitrate nitrogen concentration of 40.0 mg/L (the mass ratio of cassava lees to nitrate nitrogen is 25:1) and place it in a condition of 30° C. 14 days later, the concentration of nitrate nitrogen is 0 mg/L, the concentration of nitrite nitrogen is 0 mg/L, the COD is 68 mg/L, indicating that all nitrate nitrogen has been removed. In the control group without addition of cassava lees, the nitrogen removal rate is 4%. Thus, the effect of nitrogen removal is increased by about 25 times.

### Embodiment 16

Add the cassava lees at a dosage of 0.24 g/L into a river water simulation device with nitrate nitrogen concentration of 80.0 mg/L (the mass ratio of cassava lees to nitrate nitrogen is 3:1). Other procedures are carried out as the same as those of Embodiment 1. 14 days later, the concentration of nitrate nitrogen is 50.38 mg/L, the concentration of nitrite nitrogen is 0 mg/L, the COD is 36.8 mg/L and the final nitrogen removal rate is up to 37%. In the control group without addition of cassava lees, the nitrogen removal rate is 4%. Thus, the effect of nitrogen removal is increased by about 9 times.

### Embodiment 17

Add the cassava lees at a dosage of 1.5 g/L into a river water simulation device with nitrate nitrogen concentration of 80.0 mg/L (the mass ratio of cassava lees to nitrate nitrogen is 18.75:1). Other procedures are carried out as the same as those of Embodiment 1. 14 days later, the concentration of nitrate nitrogen is 6.37 mg/L, the concentration of nitrite nitrogen is 0 mg/L, the COD is 72.4 mg/L and the final nitrogen removal rate is up to 92.04%. In the control group without addition of cassava lees, the nitrogen removal rate is 4%. Thus, the effect of nitrogen removal is increased by about 23 times.

### Embodiment 18

Add the cassava lees at a dosage of 2.0 g/L into a river water simulation device with nitrate nitrogen concentration of 80.0 mg/L (the mass ratio of cassava lees to nitrate nitrogen is 25:1). Other procedures are carried out as the same as those of Embodiment 1. 14 days later, the concentration of nitrate nitrogen is 3.99 mg/L, the concentration of nitrite nitrogen is 0 mg/L, the COD is 76.4 mg/L and the final nitrogen removal rate is up to 95.01%. In the control group without addition of cassava lees, the nitrogen removal rate is 4%. Thus, the effect of nitrogen removal is increased by about 24 times.

### Embodiment 19

Add the cassava lees at a dosage of 1.5 g/L into a river water simulation device with nitrate nitrogen concentration of 80.0 mg/L (the mass ratio of cassava lees to nitrate nitrogen is 18.75:1) and place it in a condition of 5° C. 14 days later, the concentration of nitrate nitrogen is 10.2 mg/L, the concentration of nitrite nitrogen is 0 mg/L, the COD is 65.4 mg/L and the final nitrogen removal rate is up to 87.25%. In the control group without addition of cassava lees, the nitrogen removal rate is 4%. Thus, the effect of nitrogen removal is increased by about 22 times.

### Embodiment 20

Add the cassava lees at a dosage of 1.5 g/L into a river water simulation device with nitrate nitrogen concentration of 80.0 mg/L (the mass ratio of cassava lees to nitrate nitrogen is 18.75:1) and place it in a condition of 30° C. 14 days later, the concentration of nitrate nitrogen is 4.2 mg/L, the concentration of nitrite nitrogen is 0 mg/L, the COD is 75 mg/L and the final nitrogen removal rate is up to 94.75%. In the control group without addition of cassava lees, the nitrogen removal rate is 4%. Thus, the effect of nitrogen removal is increased by about 24 times.

The above descriptions of embodiments are conducive for ordinary technicians of the present technical field to understand and to apply the invention. It is obvious that persons skilled in the art of the present field can easily make various amendments to the above embodiments and apply the general principle illustrated in here into other embodiments without the effort of inventive work. Therefore, the present invention is not confined to embodiments herein. Any improvements and modifications conducted by persons skilled in the art of the present field according to the instructions of the present invention and without going beyond the scope of the present invention shall be included in the extent of protection of the present invention.

What is claimed is:

1. A method for biological denitrification of wastewater containing nitrates comprises the following steps: add cassava lees into water body polluted by nitrates for denitrification.

2. The method for denitrification according to claim 1, wherein the concentration of nitrate in the water body polluted by nitrates before treatment is 2-80 mg/L.

3. The method for denitrification according to claim 1, wherein the mass ratio of added cassava lees to nitrate nitrogen in the water body polluted by nitrates is 3:1-150:1.

4. The method for denitrification according to claim 1, wherein the mass ratio of added cassava lees to nitrate nitrogen in the water body polluted by nitrates is 15:1˜25:1.

5. The method for denitrification according to claim 1, wherein duration of the denitrification is 6-18 days.

6. The method for denitrification according to claim 1, wherein duration of the denitrification is 14 days.

7. The method for denitrification according to claim 1, wherein temperature of the denitrification is 5˜30° C.

8. The method for denitrification according to claim 1, wherein temperature of the denitrification is 20° C.
